(19) United States
(12) Patent Application Publication
(10) Pub. No.: US 2006/0193982 A1
(43) Pub. Date: Aug. 31, 2006

(54) Method of painting thermoplastic substrate

(75) Inventors: Antoine T. Zafera, Kitchener (CA); Stephen B. Putman, Eden Mills (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/338,003

(22) Filed: Jan. 24, 2006

Related U.S. Application Data
(60) Provisional application No. 60/646,856, filed on Jan. 25, 2005.

(51) Int. Cl. B05D 3/08

(52) U.S. Cl. 427/248.1; 427/223; 427/402

(57) ABSTRACT

Methods for combining conductive filled low surface energy substrates, such as but not limited to polyolefins, and flame applied nitrogen based coupling agents are described. The methods include adding a conductive material to a surface and or matrix of the thermoplastic substrate so as to form a conductive thermoplastic substrate and a flame applied nitrogen-based coupling agent to form functional groups on the conductive thermoplastic substrate. The methods provide improved paint transfer efficiency, paint coverage, and adhesion durability characteristics. The methods are especially suitable for paintable automotive components, such as but not limited to exterior body panels, fascias, and the like.

### CROSS-REFERENCE TO RELATED APPLICATION

The instant application claims priority to U.S. Provisional Patent Application Ser. No. 60/646,856, filed Jan. 25, 2005, the entire specification of which is expressly incorporated herein by reference.

### FIELD OF THE INVENTION

The present invention relates generally to methods for painting thermoplastic substrate and more specifically to methods for surface treatment of thermoplastic substrates so as to improve, among other things, the paint transfer efficiency, paint coverage, and adhesion durability characteristics thereof.

### BACKGROUND OF THE INVENTION

Recently, thermoplastic materials, such as thermoplastic polyolefins (TPOs), have been increasingly used in automotive applications to form various automotive components, such as exterior body panels, fascias, and the like. Thermoplastic materials are generally lighter and less expensive than metallic materials, thus allowing automotive manufacturers to reduce vehicle weight and increase fuel efficiency.

Unfortunately, TPOs, which are typically low surface energy materials, are somewhat difficult to paint so as to achieve relatively long lasting and high quality paint finishes. Various problems that have been identified with respect to painting TPOs include poor paint transfer efficiency (TE), poor adhesion durability, poor paint coverage, and the like.

Several approaches to overcome these problems have included: (1) the use of conductive TPO (e.g., treated with carbon black or the like) that were directly painted with olefinic paint so as to improve adhesion and TE; (2) plasma treatment of the TPO surface to improve adhesion; (3) the use of a process known as Sicor (i.e., Silane-on-Corona) to improve adhesion and TE; (4) flame treatment of the TPO surface to improve adhesion; (5) the use of an adhesion promoter (e.g., a chlorinated polyolefin, i.e., “CPO”) on the surface of the TPO to improve adhesion and TE; and (6) the use of a process known as ATmaP™ (i.e., Accelerated Thermo-Molecular Adhesion Process).

Although these approaches have somewhat improved the paintability of TPO substrates, they do not provide an adequate solution to all of the aforementioned problems encountered during the painting of TPO substrates. For example, the use of conductive TPO, while improving the paint coverage and TE characteristics, was deficient in providing adequate adhesion characteristics to the painted TPO. Another example concerned the use of the ATmaP™ process, which provided adequate adhesion characteristics, but was nonetheless deficient in the paint coverage and TE characteristics of the painted TPO.

Examples of the aforementioned approaches can be found with reference to U.S. Pat. Nos. 6,582,773 to Brynolf; 6,716,484 to Brynolf et al.; and 6,796,793 to Brynolf et al., and U.S. Patent Application Publication No. US2004/0213988 to Skillman, the entire specifications of all of which are expressly incorporated herein by reference.

Accordingly, there exists a need for new and improved methods for surface treatment of thermoplastic substrates, including but not limited to TPOs, so as to improve, among other things, the paint transfer efficiency, paint coverage, and adhesion durability characteristics thereof.

### SUMMARY OF THE INVENTION

It is an object of the present invention to provide new and improved methods for surface treatment of low surface energy thermoplastic substrates including but not limited to TPOs, which obviates at least one disadvantage of the prior art.

It is another object of the present invention to provide a new combination of conductive substrates with flame applied nitrogen based surface treatment for painting thermoplastic substrates, including but not limited to TPOs, so as to improve, among other things, the paint transfer efficiency, paint coverage, and adhesion durability characteristics thereof.

It is still another object of the present invention to provide a new combination of conductive substrates with flame applied nitrogen based surface treatment for painting thermoplastic substrates, including but not limited to TPOs, so as to improve, among other things, the paint transfer efficiency, paint coverage, and adhesion durability characteristics thereof, wherein the thermoplastic substrate is treated so as to be conductive and wherein the conductive thermoplastic substrate is treated with heat activated nitrogen based coupling agent to the surface thereof

In accordance with a first embodiment of the present invention, a method for painting low surface energy thermoplastic substrate is provided, combining a thermoplastic substrate, wherein the thermoplastic substrate is selected from the group consisting of non-conductive thermoplastic substrates, anti-static thermoplastic substrates, conductive thermoplastic substrates having a conductive charge, and combinations thereof, with a flame applied nitrogen-based coupling agent for forming functional groups on the thermoplastic substrate resulting in a treated surface that is attractive or receptive to paint.

In accordance with a second embodiment of the present invention, a method for painting low surface energy thermoplastic polyolefin substrate by combining conductive filled thermoplastic substrate is provided, comprising: (1) adding a conductive material to a surface or matrix of the thermoplastic polyolefin substrate so as to form a conductive thermoplastic polyolefin substrate having a conductive charge; and (2) causing a nitrogen-based coupling agent to be chemically bound to the conductive thermoplastic polyolefin substrate to form a surface treated thermoplastic polyolefin substrate.

By “matrix,” as that term is used herein, it is meant the portion of the substrate underling the surface thereof, and includes all of the various materials comprising the substrate.

In accordance with a third embodiment of the present invention, a method for surface treating a thermoplastic polyolefin substrate is provided, comprising: (1) adding a conductive material to a surface or matrix of the thermoplastic polyolefin substrate so as to form a conductive thermoplastic polyolefin substrate having a conductive charge, wherein the conductive material is selected from the group consisting of carbon black, nanotubes, carbon fibers, metallic powders, conductive rubber, ionic polymers, polymeric powders, semiconductor powders, doped semiconductor powders, and combinations thereof; and (2) applying a flame applied nitrogen-based coupling agent for forming functional groups on the conductive thermoplastic substrate to form a surface treated thermoplastic polyolefin substrate, wherein the nitrogen-based coupling agent is comprised of at least one oxide of nitrogen.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a flow chart of a nitrogen coupling agent treatment at the press of a non-conductive substrate, in accordance with one embodiment of the present invention;

FIG. 2 illustrates a flow chart of a nitrogen coupling agent treatment at the press of an anti-static substrate, in accordance with a second embodiment of the present invention;

FIG. 3 illustrates a flow chart of a nitrogen coupling agent treatment at the press of a conductive substrate, in accordance with a third embodiment of the present invention;

FIG. 4 illustrates a flow chart of a nitrogen coupling agent treatment on a paint line, before a cleaning step, of a non-conductive substrate, in accordance with a fourth embodiment of the present invention;

FIG. 5 illustrates a flow chart of a nitrogen coupling agent treatment on a paint line, before a cleaning step, of an anti-static substrate, in accordance with a fifth embodiment of the present invention;

FIG. 6 illustrates a flow chart of a nitrogen coupling agent treatment on a paint line, before a cleaning step, of a conductive substrate, in accordance with a sixth embodiment of the present invention;

FIG. 7 illustrates a flow chart of a nitrogen coupling agent treatment on a paint line, after a cleaning step, of a non-conductive substrate, in accordance with a seventh embodiment of the present invention;

FIG. 8 illustrates a flow chart of a nitrogen coupling agent treatment on a paint line, after a cleaning step, of an anti-static substrate, in accordance with an eighth embodiment of the present invention; and

FIG. 9 illustrates a flow chart of a nitrogen coupling agent treatment on a paint line, after a cleaning step, of a conductive substrate, in accordance with a ninth embodiment of the present invention.

### DETAILED DESCRIPTION OF THE INVENTION

The following description of the preferred embodiment(s) is merely exemplary in nature and is in no way intended to limit the invention, its application, or uses.

In accordance with the general teachings of the present invention, methods are provided for surface treatment of thermoplastic substrates, including but not limited to TPOs, so as to improve, among other things, the paint transfer efficiency, paint coverage, and adhesion durability characteristics thereof.

In accordance with one aspect of the present invention, the thermoplastic substrate, regardless of chemical composition, has a conductive charge imparted thereto, regardless of methodology. In accordance with a preferred embodiment of the present invention, the conductive charge is preferably present on an exterior surface of the thermoplastic substrate, especially the surface that is to be painted, or the paintable surface. It should be appreciated that the thermoplastic substrate can also be provided with a conductive charge throughout the entirety or a portion of the entirety of the thermoplastic substrate body. That is, the conductive charge could be dispersed completely or partially throughout the thermoplastic substrate body.

In accordance with a preferred embodiment of the present invention, any thermoplastic material can be used in the practice of the present invention. By way of a non-limiting example, the thermoplastic substrate of the present invention is preferably selected from the group consisting of polyolefins, polystyrenes, polyesters, polycarbonates, acrylonitrile-butadiene-styrene copolymer, high-impact polystyrene, high-density polyethylene, high molecular weight polyethylene, polypropylene, polyvinyl chloride, polyethylene terephthalate, and combinations thereof.

In accordance with a preferred embodiment of the present invention, the electrically conductive material to be applied or otherwise combined with the thermoplastic substrate, can comprise any physical form, such as but not limited to layers, sheets, tubes, fibers, pulp, powders, granules, grains, and the like.

The electrically conductive powder can include any powder that is comprised of electrically conducting particles. Preferably, the electrically conductive powder is selected from the group consisting of electrically conductive carbon black, electrically conductive carbon nanotubes, carbon fibers, metallic powders, metallic fibers, conductive rubber, ionic conductive polymers, conductive polymeric powder (e.g., polypyrrole), semiconductor powders, doped semiconductor powders, and combinations thereof.

The electrically conductive material, e.g., a layer, can preferably be applied to the thermoplastic substrate by a number of suitable methods known in the art, such as but not limited to spraying, rolling, pouring, brushing, mixing, extruding, laminating, vacuum forming, thermoforming, and the like. Regardless of the method used or the electrically conductive material chosen, an electrically conductive surface is preferably formed on a surface area of the thermoplastic substrate.

Once the conductive charge has been applied to the surface of the thermoplastic substrate, the subsequent addition of a coupling agent to the surface of the thermoplastic substrate can preferably be accomplished.

In accordance with a preferred embodiment of the present invention, a proprietary system generally referred to as ATmaP™ (FTS Technologies, Inc., Flint, Mich.) is used. This system preferably employs a Cirqual™ gas burner that is attached to a robotic arm in order to surface treat both flat and three dimensional surfaces alike. However, this system is not the same as traditional flame treatment, but rather includes several significant differences.

The system preferably employs a highly controlled flame delivered by the Cirqual™ burner, using either natural gas or propane that is generated with the control of oxygen content in the range of 0.2%-1.7%, depending on the material being processed. A diimine compound is preferably solubilized in water at less than 1.0% mix ratio. This “water-borne” solution is then preferably atomized into the flame via an internal mix spray gun, located in the center of the Cirqual™ burner. The spray gun is preferably operable to generate low velocities yet high atomization. The highly atomized liquid is then preferably vaporized within the flame and generates an active chemistry that in turn is carried to the surface of the material/molding (in this case, the thermoplastic substrate), by the flame itself. The total volume of liquid sprayed is preferably no more than 25 ccm. The atomizing media used is preferably nitrogen (e.g., oxygen free) at volumes of no more than 12-15 l/min. Nitrogen is preferably used because it is an inert gas and therefore does not affect the O₂ content of the flame itself. Nitrogen is also capable of, and reacts to, changes in polarity. In accordance with a preferred embodiment of the present invention, hydroxyl, carboxyl, and/or diimine-derived functionality's (i.e., oxides of nitrogen) are preferably chemically bonded into the surface of the thermoplastic substrate being treated. Without being bound to a particular theory of the operation of the present invention, it is believed that these functional groups cause variations in electronegativity across the surface of the thermoplastic substrate, which enhances adhesion (e.g., for painting, bonding, laminating, and the like).

The methods of the present invention can be used to paint any conductive thermoplastic substrate, including those that have any type of surface configuration, such as but not limited to planar surfaces, curved surfaces, folded surfaces, stepped surfaces, convex/concave surfaces, and the like.

Once the conductive thermoplastic substrate has been treated as previously described, it can then be painted by any number of conventional methods, such as but not limited to electrostatic painting methods.

To more clearly describe the primary processing steps mentioned above, reference is made to FIGS. 1-6, which describe various methodologies for treating various substrates, in accordance with the general teachings of the present invention.

Referring to FIG. 1, there is illustrated a flow chart of a nitrogen coupling agent treatment at the press of a non-conductive substrate, in accordance with one embodiment of the present invention. The first step 10 is to mold the non-conductive substrate into the desired shape, e.g., an automotive component. The next step 20 is to apply the nitrogen-based coupling agent surface treatment at the press. The next step 30 is to clean the treated part. The next step 40 is to apply a color coat (e.g., paint) to the treated part. The next step 50 is to apply a clear coat, e.g., to the color coat, if present. The next step 60 is to bake out the part as required, e.g., to cure the various coatings, if present. The finished component is then ready for shipment and/or installation.

Referring to FIG. 2, there is illustrated a flow chart of a nitrogen coupling agent treatment at the press of an anti-static substrate, in accordance with a second embodiment of the present invention. The process is essentially identical to the process shown in FIG. 1, except that an anti-static substrate is used. The first step 100 is to mold the anti-static substrate into the desired shape, e.g., an automotive component. The next step 110 is to apply the nitrogen-based coupling agent surface treatment at the press. The next step 120 is to clean the treated part. The next step 130, which is optional, is to apply a color coat (e.g., paint) to the treated part. The next step 140 is to apply a clear coat, e.g., to the color coat, if present. The next step 150 is to bake out the part as required, e.g., to cure the various coatings, if present. The finished component is then ready for shipment and/or installation.

Referring to FIG. 3, there is illustrated a flow chart of a nitrogen coupling agent treatment at the press of a conductive substrate, in accordance with a third embodiment of the present invention. The process is essentially identical to the processes shown in FIGS. 1 and 2, except that a conductive substrate is used. The first step 200 is to mold the anti-static substrate into the desired shape, e.g., an automotive component. The next step 210 is to apply the nitrogen-based coupling agent surface treatment at the press. The next step 220 is to clean the treated part. The next step 230 is to apply a color coat (e.g., paint) to the treated part. The next step 240 is to apply a clear coat, e.g., to the color coat, if present. The next step 250 is to bake out the part as required, e.g., to cure the various coatings, if present. The finished component is then ready for shipment and/or installation.

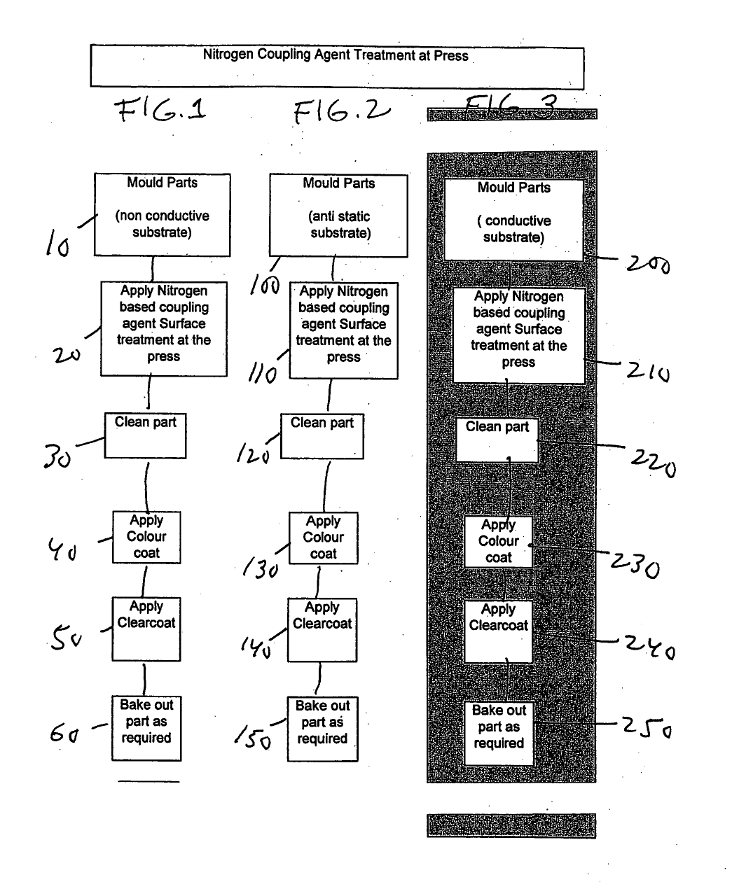

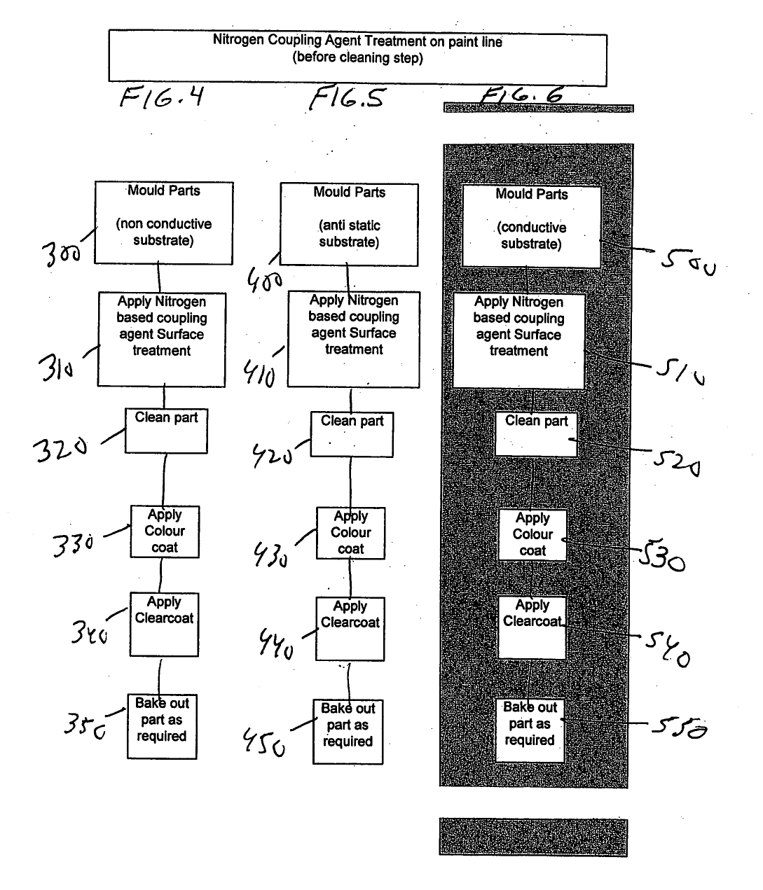

Referring to FIG. 4, there is illustrated a flow chart of a nitrogen coupling agent treatment on a paint line of a non-conductive substrate, in accordance with a fourth embodiment of the present invention. The process is somewhat similar to the processes shown in FIGS. 1-3, except that the process is carried out on a paint line before the cleaning step, as opposed to at the press. The first step 300 is to mold the anti-static substrate into the desired shape, e.g., an automotive component. The next step 310 is to apply the nitrogen-based coupling agent surface treatment. The next step 320 is to clean the treated part. The next step 330 is to apply a color coat (e.g., paint) to the treated part. The next step 340 is to apply a clear coat, e.g., to the color coat, if present. The next step 350 is to bake out the part as required, e.g., to cure the various coatings, if present. The finished component is then ready for shipment and/or installation.

Referring to FIG. 5, there is illustrated a flow chart of a nitrogen coupling agent treatment on a paint line of an anti-static substrate, in accordance with a fifth embodiment of the present invention. The process is essentially identical to the process shown in FIG. 4, except that an anti-static substrate is used. The first step 400 is to mold the anti-static substrate into the desired shape, e.g., an automotive component. The next step 410 is to apply the nitrogen-based coupling agent surface treatment. The next step 420 is to clean the treated part. The next step 430 is to apply a color coat (e.g., paint) to the treated part. The next step 440 is to apply a clear coat, e.g., to the color coat, if present. The next step 450 is to bake out the part as required, e.g., to cure the various coatings, if present. The finished component is then ready for shipment and/or installation.

Referring to FIG. 6, there is illustrated a flow chart of a nitrogen coupling agent treatment on a paint line of a conductive substrate, in accordance with a sixth embodiment of the present invention. The process is essentially identical to the processes shown in FIGS. 4 and 5, except that a conductive substrate is used. The first step 500 is to mold the anti-static substrate into the desired shape, e.g., an automotive component. The next step 510 is to apply the nitrogen-based coupling agent surface treatment. The next step 520 is to clean the treated part. The next step 530 is to apply a color coat (e.g., paint) to the treated part. The next step 540 is to apply a clear coat, e.g., to the color coat, if present. The next step 550 is to bake out the part as required, e.g., to cure the various coatings, if present. The finished component is then ready for shipment and/or installation.

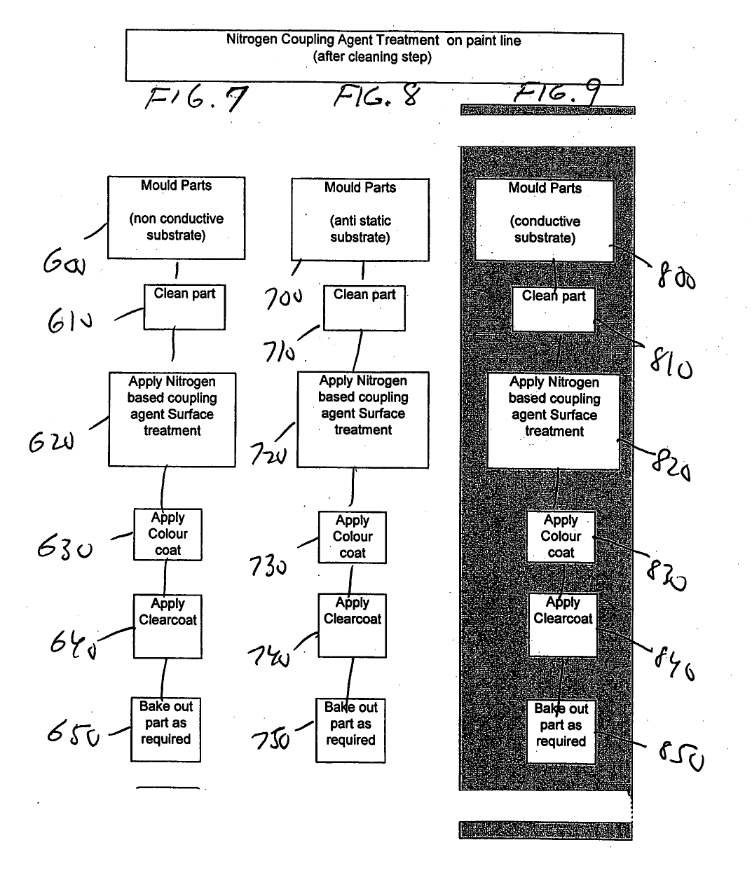

Referring to FIG. 7, there is illustrated a flow chart of a nitrogen coupling agent treatment on a paint line of a non-conductive substrate, in accordance with a seventh embodiment of the present invention. The process is somewhat similar to the processes shown in FIGS. 4-6, except that the process is carried out on a paint line after the cleaning step, as opposed to before the cleaning step. The first step 600 is to mold the anti-static substrate into the desired shape, e.g., an automotive component. The next step 610 is to clean the treated part. The next step 620 is to apply the nitrogen-based coupling agent surface treatment. The next step 630 is to apply a color coat (e.g., paint) to the treated part. The next step 640 is to apply a clear coat, e.g., to the color coat, if present. The next step 650 is to bake out the part as required, e.g., to cure the various coatings, if present. The finished component is then ready for shipment and/or installation.

Referring to FIG. 8, there is illustrated a flow chart of a nitrogen coupling agent treatment on a paint line of an anti-static substrate, in accordance with an eighth embodiment of the present invention. The process is somewhat similar to the process shown in FIG. 7, except that the process is carried out on an anti-static substrate. The first step 700 is to mold the anti-static substrate into the desired shape, e.g., an automotive component. The next step 710 is to clean the treated part. The next step 720 is to apply the nitrogen-based coupling agent surface treatment. The next step 730 is to apply a color coat (e.g., paint) to the treated part. The next step 740 is to apply a clear coat, e.g., to the color coat, if present. The next step 750 is to bake out the part as required, e.g., to cure the various coatings, if present. The finished component is then ready for shipment and/or installation.

Referring to FIG. 9, there is illustrated a flow chart of a nitrogen coupling agent treatment on a paint line of a conductive substrate, in accordance with a ninth embodiment of the present invention. The process is somewhat similar to the process shown in FIGS. 7 and 8, except that the process is carried out on a conductive substrate. The first step 800 is to mold the anti-static substrate into the desired shape, e.g., an automotive component. The next step 810 is to clean the treated part. The next step 820 is to apply the nitrogen-based coupling agent surface treatment. The next step 830 is to apply a color coat (e.g., paint) to the treated part. The next step 840 is to apply a clear coat, e.g., to the color coat, if present. The next step 850 is to bake out the part as required, e.g., to cure the various coatings, if present. The finished component is then ready for shipment and/or installation.

To evaluate the performance of the present invention, a comparative test was conducted.

The transfer efficiency characteristics samples, prepared in accordance with the present invention, were about as good as conventional samples prepared with an adhesion promoter. Improved transfer efficiency performance is realized with the present invention over conventional samples (e.g., sample #1) that did not use conductive TPO, as shown in the Table, below:

| | TABLE | | | |
|---|---|---|---|---|
| | TE/ATmaP ™ Summary | | | |
| | Sample #1 | | | |
| | Conventional | | | Sample #4 |
| | Non-Conductive | Sample #2 | Sample #3 | Non- |
| | TPO and | Conductive | Anti-Static | Conductive |
| | Adhesion | TPO and | TPO and | TPO and |
| | Promoter | ATmaP ™ | ATmaP ™ | ATmaP ™ |
| Transfer | 15 to 20% | 15 to 20% | Equivalent | Baseline |
| Efficiency | improvement | improvement | to baseline | |
| (TE) (%) | over baseline | over baseline | | |
| (Base Coat | | | | |
| and Clear | | | | |
| Coat only) | | | | |

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for painting low surface energy thermoplastic substrate, comprising:
combining a thermoplastic substrate, wherein the thermoplastic substrate is selected from the group consisting of non-conductive thermoplastic substrates, anti-static thermoplastic substrates, conductive thermoplastic substrates having a conductive charge, and combinations thereof, with a flame applied nitrogen-based coupling agent for forming functional groups on the thermoplastic substrate resulting in a treated surface that is attractive or receptive to paint.

2. The invention according to claim 1, wherein the thermoplastic substrate is comprised of a polyolefin material.

3. The invention according to claim 1, wherein the conductive charge is provided by a material that is selected from the group consisting of carbon black, nanotubes, carbon fibers, metallic powders, conductive rubber, ionic polymers, polymeric powders, semiconductor powders, doped semiconductor powders, and combinations thereof.

4. The invention according to claim 1, wherein the nitrogen-based coupling agent is comprised of at least one oxide of nitrogen.

5. The invention according to claim 4, wherein the nitrogen-based coupling agent is atomized and vaporized by a heat source so as to form the at least one oxide of nitrogen.

6. The invention according to claim 1, further comprising applying a colorant or coating to at least a portion of the surface treated thermoplastic substrate.

7. The invention according to claim 1, wherein the surface treated thermoplastic substrate comprises an automotive component.

8. A method for painting low surface energy thermoplastic polyolefin substrate by combining conductive filled thermoplastic substrate, comprising:
adding a conductive material to a surface or matrix of the thermoplastic polyolefin substrate so as to form a conductive thermoplastic polyolefin substrate having a conductive charge; and
causing a nitrogen-based coupling agent to be chemically bound to the conductive thermoplastic polyolefin substrate to form a surface treated thermoplastic polyolefin substrate.

9. The invention according to claim 8, wherein the conductive charge is provided by a material is selected from the group consisting of carbon black, nanotubes, carbon fibers, metallic powders, conductive rubber, ionic polymers, polymeric powders, semiconductor powders, doped semiconductor powders, blends mixtures and combinations thereof.

10. The invention according to claim 8, wherein the nitrogen-based coupling agent is comprised of at least one oxide of nitrogen.

11. The invention according to claim 10, wherein the nitrogen-based coupling agent is atomized and vaporized by a heat source so as to form the at least one oxide of nitrogen.

12. The invention according to claim 8, further comprising applying a colorant to at least a portion of the surface treated thermoplastic polyolefin substrate.

13. The invention according to claim 8, wherein the surface treated thermoplastic polyolefin substrate comprises an automotive component.

14. A method for surface treating a thermoplastic polyolefin substrate, comprising:
adding a conductive material to a surface or matrix of the thermoplastic polyolefin substrate so as to form a conductive thermoplastic polyolefin substrate having a conductive charge, wherein the conductive material is selected from the group consisting of carbon black, nanotubes, carbon fibers, metallic powders, conductive rubber, ionic polymers, polymeric powders, semiconductor powders, doped semiconductor powders, and combinations thereof; and
applying a flame applied nitrogen-based coupling agent for forming functional groups on the conductive thermoplastic substrate to form a surface treated thermoplastic polyolefin substrate, wherein the nitrogen-based coupling agent is comprised of at least one oxide of nitrogen.

15. The invention according to claim 14, wherein the nitrogen-based coupling agent is atomized and vaporized by a heat source so as to form at least one oxide of nitrogen.

16. The invention according to claim 14, further comprising applying a colorant or coating to at least a portion of the surface treated thermoplastic polyolefin substrate.

17. The invention according to claim 14, wherein the surface treated thermoplastic polyolefin substrate comprises an automotive component.
